(19) United States
(12) Patent Application Publication
(10) Pub. No.: US 2002/0056707 A1
(43) Pub. Date: May 16, 2002

(54) Welding of carpets to panels

(76) Inventors: George Pinho, Waterloo (CA); Melih Ogmen, Ariss (CA)

Correspondence Address: Orange & Chari, Suite 4900, 66 Wellington Street, P.O. Box 190, Toronto, ON, M5K 1H6, CA

(21) Appl. No.: 09/984,426

(22) Filed: Oct. 30, 2001

Related U.S. Application Data
(60) Provisional application No. 60/131,844, filed on Apr. 30, 1999.

(30) Foreign Application Priority Data
Apr. 28, 2000 (CA) PCT/CA00/00459

(51) Int. Cl. B23K 26/32

(52) U.S. Cl. 219/121.64; 428/85

(57) ABSTRACT

A system and method for using a laser to weld a plastic substrate material to an adjacent material, such as a synthetic carpet panel. The materials are placed in contact with oppositely directed major surfaces, so as to provide an interface therebetween. The material closest to the laser is transparent to a wavelength of the laser beam, so that the impinging laser beam can be focused at a focal region on the interface. The other material adjacent to the interface is absorbent to the wavelength, so that heating of the other material by the laser beam causes a pattern of a plurality of melt zones to be formed, each melt zone consisting of portions of each of the materials. Subsequent cooling of the melt zones causes the adjacent materials to become welded together. Additives are combined with the materials to modify their transmission and absorption characteristics with respect to visible light and laser wavelengths.

### FIELD OF INVENTION

This invention relates to a method and apparatus for manufacturing laminated panels such as but not limited to door panels, kick panels, instrument panels, rear decks, seat backs, and consoles for the automotive industry.

### BACKGROUND OF THE INVENTION

A laminated panel such as a carpeted panel typically consists of a thermoplastic substrate, normally made of ABS, Nylon, PE, or PP plastic, onto which is bonded a synthetic fiber carpet with a thermoplastic backing. The carpet is mated to the plastic substrate and must fit properly so that no excessive gaps or spaces are present between the substrate and the carpet.

Various means of attaching such carpet material already exist, for instance, mechanical stapling of the carpet to the substrate, the use of adhesives, and other mechanical fasteners. These methods are often time consuming, visually unappealing, and generally result in the failure of the fasteners or adhesives over time.

Another method of fastening uses ultrasonic or vibration welding to attach the carpet to the substrate. Various problems exist with these methods. Ultrasonic welding tends to leave visual weld marks where the horn of the welder has made contact with the surface and is only suitable for spot welding. Vibration welding is limited to mostly flat surfaces, or simple three-dimensional parts with rigid backings, and requires complex securing mechanisms in order to vibrate the parts together.

It is therefore an object of the present invention to provide the method and materials that obviate or mitigate the above disadvantages.

### SUMMARY OF THE INVENTION

According to one aspect, the invention comprises a system for laminating a pair of panels having dissimilar optical characteristics such that one of the panels is transparent to laser radiation at a predetermined wavelength and another is substantially absorbent thereto. The system includes a support to locate the panels with oppositely directed major surfaces in abutment to provide an interface between the panels and a laser to provide a beam of coherent radiation at the predetermined wavelength. The laser is focused at the interface to produce a melt zone. The laser is displaceable relative to the support to cause the beam to impinge the one panel and be transmitted therethrough to produce a plurality of melt zones formed at said interface. Each of the melt zones consist of a portion of each of the panels at the interface, whereby upon cooling the panels become welded to one another.

According to a further aspect of the invention there is provided a method of laminating a pair of panels of differing optical characteristics with one of the panels being transparent to a predetermined wavelength and a second panel being substantially absorbent thereto, comprising the steps of:

(a) positioning oppositely directed major surfaces of the panels in contact to provide an interface therebetween;

(b) transmitting the laser beam of predetermined wavelength through the one panel to the interface;

(c) focusing the laser beam at a focal region on the interface;

(d) applying the laser to heat and melt a portion of the second panel at the interface;

(e) displacing the laser beam relative to the panels to melt a plurality of portions of the panels adjacent to the focal region to produce a corresponding plurality of melt zones formed at the interface, each of the melt zones consisting of a mixture of the portions of the panels; and

(f) cooling of the melt zone so that the panels become welded at the interface.

In one embodiment, the present invention involves the use of a laser to weld a plastic substrate to a carpet primarily for carpeted vehicle interior panels. The carpet is normally mounted on a flexible or rigid backing and positioned on a plastic substrate, which can be of a planar or three-dimensional shape. The welding apparatus includes a robot-controlled laser focussed onto the interface between the substrate and the carpet, normally from the substrate side but the laser may also be positioned on the carpet side. The radiation from the laser is absorbed by the plastic and causes the interface to melt, and when the materials are compatible a weld occurs.

Preferably a continuous wave fiber-coupled diode laser is utilized. Pigments and dyes, either absorbent or transparent to the laser, are used in the plastic material to control the degree and location of localized heating. Certain combinations of individual pigments or dyes may be used to obtain solid colors in the visible spectrum, such as black, which are transparent to the wavelength of the laser. Impact modifiers can also be added to the plastic to generate localized heating and alter the physical characteristics of the plastic material.

Whilst some heat damage may occur on the back of the substrate where the laser beam was focussed, the substrate is not usually visible in the final product. This welding process also minimizes visible heat damage to the carpet fibers. The laser can weld the carpet by spot, stitch, or continuous welding patterns. Complex three-dimensional surfaces can be followed and welded easily by the robot.

### BRIEF DESCRIPTION OF THE DRAWINGS

Embodiments of the invention will now be described by way of example only with reference to the accompanying drawings, in which

FIG. 1 is a cross sectional view of a carpet laser welding assembly.

FIG. 2 illustrates a number of possible welding patterns.

FIG. 3 is an alternative embodiment of the apparatus for welding of carpets with absorbent fibers.

FIG. 4 shows the welding of a carpet to a three-dimensional surface.

FIG. 5 shows transparency characteristics of dye and pigments.

### DETAILED DESCRIPTION OF THE PREFERRED EMBODIMENTS

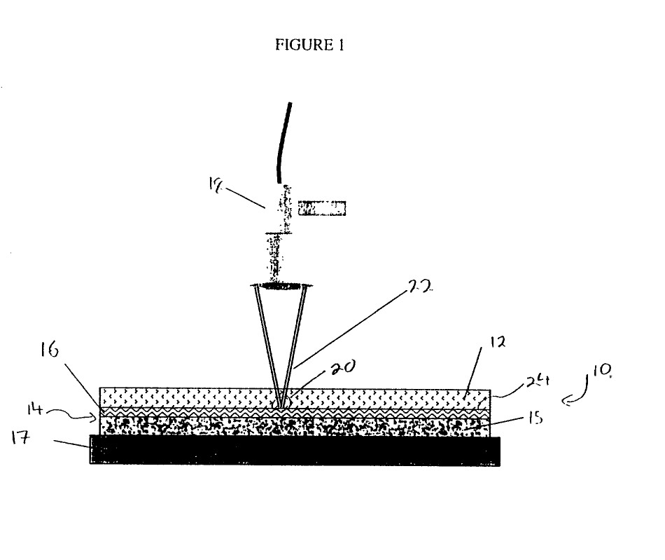

Referring to FIG. 1, a laminated trim-piece (10) is formed from a pair of panels including a thermoplastic substrate (12), and a carpet overlay (14). The carpet (14) includes a pile (15) secured to a thermoplastic backing (16). The panels of the trim-piece (10) are held in a cradle (17) during assembly with oppositely directed surfaces, in intimate contact to define an interface 24.

The material of the panels are selected to exhibit different optical properties so that the substrate (12) is chosen to be transparent to the wavelength of the laser (22) and the backing (16) absorbent.

A robot (not shown) positions a laser welding head (18) on the substrate (12) side, so that a laser beam (22) is focused as indicated at (20) at an interface (24) between the substrate (12) and the carpet backing (16). The type of laser beam (22) used in this approach is a continuous wave diode laser operating at 808 nm or 940 nm, however an Nd:YAG or a CO₂ laser spanning the wavelength range 500 nm to 10600 nm can also be used.

When the laser beam (22) impinges on the substrate (12), it is transmitted to the interface (24). Absorption of the laser radiation by the backing (16) at the focal region (20) causes heating at the interface (24), which melts the substrate (12) and the backing (16). Upon cooling, the substrate (12) and the backing (16) become welded at the interface (24).

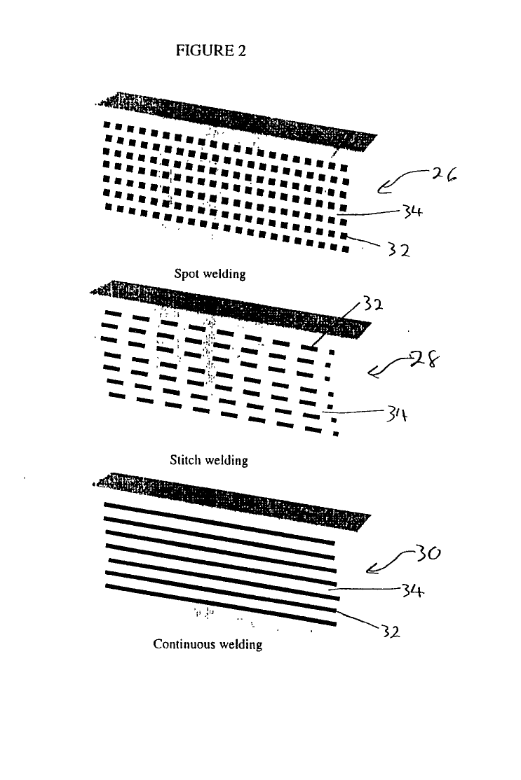

Several styles of welding patterns can be applied to secure the carpet backing (16) to the substrate (12), some examples of which are shown in FIG. 2. The patterns of spot (26), stitch (28), or continuous welding (30) were used in initial testing, wherein the spacing (34) between the individual weld locations (32) was limited to 2.5 cm. The width of the welds (32) used are preferably one millimeter, but can be made larger by increasing the laser power and defocusing the beam (22). Typical welding times can range from 20 seconds to 45 seconds, depending upon the surface area of the substrate (12) and backing (16), and the number of welds (32) required. The required power of the laser beam (22) varied between 50 and 100 W with transverse speeds ranging from 1 to 3 m/min. If desired, shorter welding times and faster speeds may be obtained with higher intensity laser beams (22).

The carpet pile (15) and backing (16) will typically be made from a polymeric material, usually a thermoplastic. Uncolored polymers are nearly 100% transparent to diode and Nd:YAG laser radiation. To enhance heating at the interface, the carpet backing (16) can include a pigment, such as carbon black that is absorbent at the wavelength of the laser beam (22). This pigmentation therefore increases the absorption of the laser radiation of the carpet backing (16). When the laser beam (22) strikes the interface (24), the transparent substrate (12) does not absorb the laser radiation but the carpet backing (16), with the imbedded pigment, absorbs the laser radiation and melts. This in turn causes the localised melting of the substrate (12) and the bonding of the substrate (12) and carpet backing (16) together. Since relatively little absorption occurs in the substrate (12), as compared to the carpet backing (16), visible damage is minimized on the substrate (12) or the carpet fibers (14).

Weldable pairings of materials investigated include; polyethylene-polyethylene, polyethylene-polypropylene, polypropylene-polypropylene, rubber-rubber, rubber UHMW polyethylene, and UHMW-UHMW. The use of polyethylene and polypropylene materials in the manufacture of carpet panels (10) is made possible through laser welding, as these materials typically cannot be glued together. The use of polyethylene and polypropylene materials in carpet panels (10) also represents significant cost savings over the typical use of ABS and nylon materials, which are glueable but more expensive.

In a further embodiment, impact modifier examples can be added to the substrate (12) or carpet backing (16). The presence of these modifiers attenuates the laser beam (22) striking the plastic material and therefore causes local heating to occur, which welds the substrate (12) and adjacent backing (16) together.

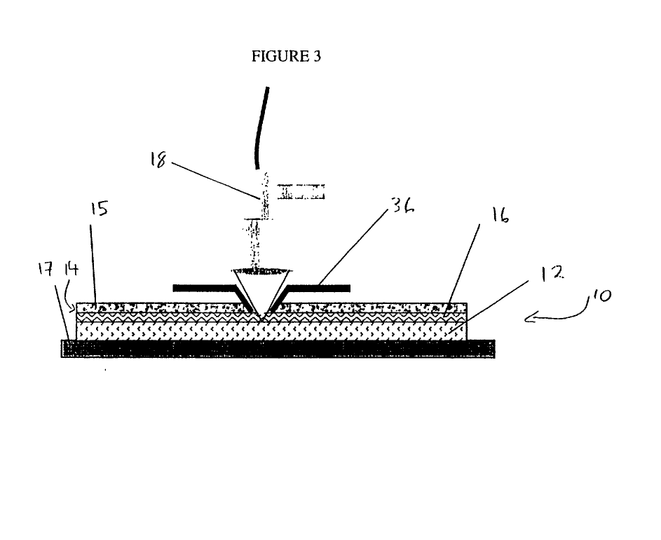

An alternative embodiment, shown in FIG. 3, is to choose the fibers of pile (15) and backing (16) from material such as polypropylene, and color them with pigment or dyes transparent to the laser radiation. Tile substrate (12) can then be colored with an absorbent pigment such as carbon black and the carpet backing (16) is welded to the substrate (12) from the carpet side. Absorption of radiation only occurs at the surface of the substrate (12), thereby bonding the substrate (12) and the backing (16) together. This process can minimize potential damage to the carpet fibers (14).

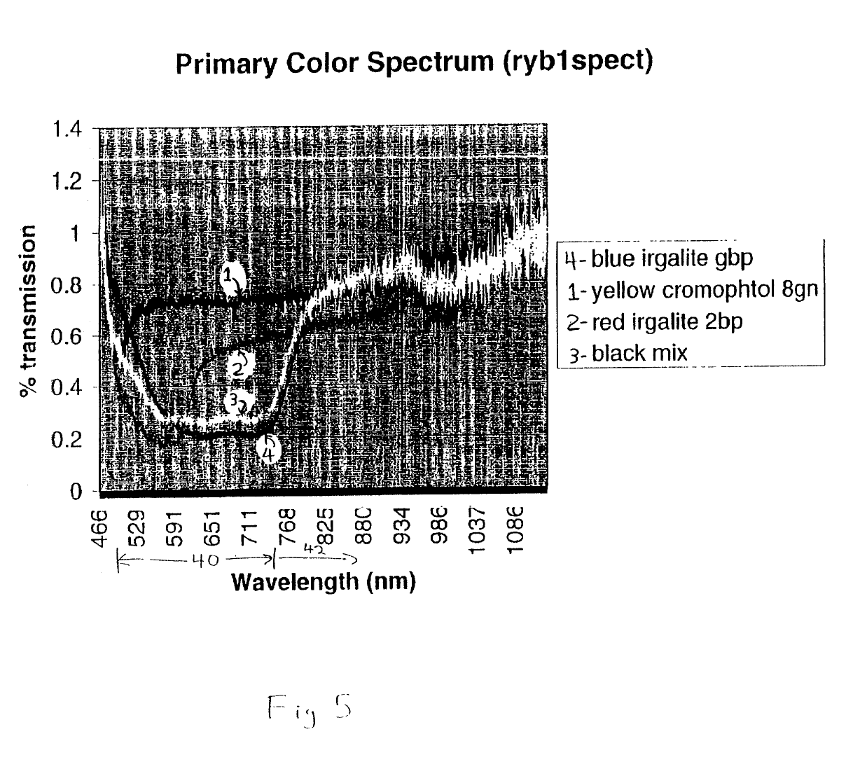

Many applications in the automotive industry, require a black carpet which is typically absorbent to laser radiation. To obviate this, the materials of the carpet may be coloured with a pigment or dye which is substantially absorbtive i.e. black, in the visible spectrum but which is transparent to the radiation of the laser beam (22). This may be obtained by mixing pigments or dyes of the primary colors red, yellow and blue exhibiting transparency to the wavelength of the laser beam (22). Suitable pigments that have been used to provide a visible black colour that is optically transparent at laser wavelengths are available from Ciba Geigy as follows; blue—iragalite gbp, yellow—cromophtol 8gn, and red iragalite 2bp. Each exhibit the individual spectral characteristics shown in FIG. 5. When mixed in the proportion of 1:1:0.5 (blue-yellow-red) a black color is obtained in the visible spectrum but high transmission is retained at the wavelength of the laser beam (22).

Alternative pigments are; red—iragalite rubine 4bp, blue—cromophtol a3r, and yellow—iragalite wgp.

Generally, pigments of primary colours exhibiting high transmission to laser wavelength but low transmission to the required visible wavelength may be mixed to obtain the requisite attributes and added to the polymer of the carpet fibers (14). The optical characteristics, shown in FIG. 5, illustrate a distinct absorptive region (40) and transmissive region (42), located in the infrared spectrum.

A further embodiment, shown in FIG. 3, demonstrates how the fibers of pile (15), potentially radiation absorbent, could be separated mechanically by a shoe (36), which reveals the carpet backing (16) and allows the laser beam (22) to weld the substrate (12) and the carpet backing (16) together. The shoe (36) moves with the laser head (18) to progressively expose the backing (16). When the welding process is completed, the carpet fibers (14) are released to move back into a natural position. This process could be used when carpet fibers (14) are generally absorbent to the laser beam (22) and the back of the substrate (12) is not accessible.

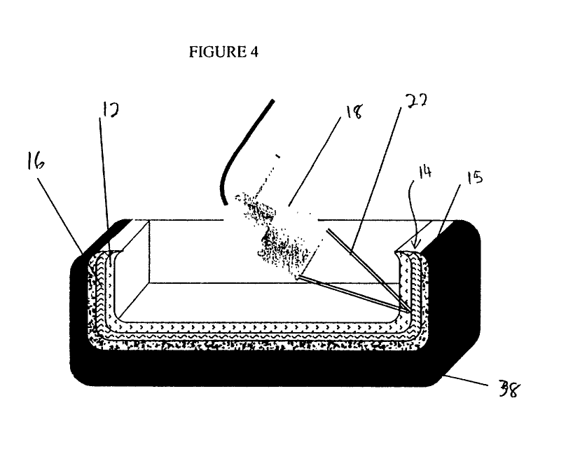

In another embodiment, the process of laser welding with a robot can also be applied to a complex three-dimensional part (38), shown in FIG. 4. Since laser welding is a non-contact process, shapes of parts are easily welded by the laser which are difficult to weld by vibration. The substrate (12) is preferably made from polypropylene or polyethylene material. The carpet backing (16) is preferably made from polypropylene or polyethylene, while the carpet fibers of pile (15) are made from nylon or polypropylene. Other materials may be used as appropriate. The laser power required for this operation typically varies between 50 watts to 100 watts for the desired material thicknesses, ranging between 0.3 cm and 1.3 cm respectively. The focal length of the lens used in the laser (18) is 2 inches, but different focal lengths may be used depending upon material properties or geometry. The laser head (18) is manipulated by a robot to follow closely the contours of the part (38) and maintain the focus of the laser at the interface between the backing (16) and substrate (12).

The welding pattern (26), (28), (30) can be other than shown, the weld (32) spacing other than one inch, the weld thickness other than 1 mm, and the welding times other than indicated. The type of laser used in welding can be other than diode laser and Nd:YAG. Any complex shape or shapes can be used, where the geometry is only limited by access of the laser beam (22).

Although the invention has been described with reference to certain specific embodiments, various modifications thereof will be apparent to those skilled in the art without departing from the spirit and scope of the invention as outlined in the claims appended hereto.

The embodiments of the invention in which an exclusive Property or privilege is claimed are defined as follows:

1. A system for laminating a pair of panels having dissimilar optical characteristics such that one of said panels is transparent to laser radiation at a predetermined wavelength and a second of said panels is substantially absorbent thereto, said system comprising: a support to locate said panels with oppositely directed major surfaces in abutment to provide an interface between said panels; and a laser to provide a beam of coherent radiation at said predetermined wavelength, said laser being focussed at said interface to produce a melt zone, said laser being displaceable relative to said support to cause said beam to impinge said one panel and be transmitted therethrough to produce a plurality of melt zones formed at said interface; each of said melt zones consisting of a portion of each of said panels at said interface, whereby upon cooling said panels become welded to one another.

2. A system for welding according to claim 1, wherein said second panel includes an additive for enhancing absorption characteristics of said beam at said predetermined wavelength.

3. A system for welding according to claim 2, wherein said additive is selected from the group comprising pigments and dyes.

4. A system for welding according to claim 3, wherein said additive is carbon black.

5. A system for welding according to claim 2, wherein said additive is an impact modifier.

6. A system for welding according to claim 1, wherein said one panel includes an additive which is substantially absorbent to visible spectrum radiation and substantially transparent to radiation of said laser beam.

7. A system for welding according to claim 6, wherein said additive is selected from the group comprising pigments and dyes.

8. A system for welding according to claim 7, wherein said additive is a mixture of primary colors.

9. A system for welding according to claims 1 to 8, wherein said panels comprise polymers selected from the group comprising polyethylene, polypropylene, rubber, and UHMW.

10. A system for welding according to claims 1 and 9, wherein said predetermined wavelength is in the range 500 nm to 10,600 nm.

11. A system for welding according to claim 10, wherein said laser is a Nd:YAG laser.

12. A system for welding according to claim 10, wherein said laser is a diode laser.

13. A system for welding according to claim 1, wherein a pattern of said plurality of melt zones is selected from the group comprising spot, stitch, and continuous welds.

14. A system for welding according to claim 1, wherein said one panel includes a plurality of fibers providing a carpet pile and secured to a backing, said pile being located on an exterior surface of said backing spaced apart from said interface.

15. A system for welding according to claim 14 further comprising a separator for spreading laser radiation absorbent ones of said carpet fibers to expose a portion of said exterior surface of said backing, whereby said laser beam impinges upon said interface.

16. A system for welding according to claim 14, wherein said fibers are substantially transparent to said wavelength of said laser beam.

17. A method of laminating a pair of panels of differing optical characteristics with one of said panels being transparent to coherent radiation at a predetermined wavelength and a second of said panels being substantially absorbent to said predetermined wavelength, the method comprising the steps of:
(a) positioning oppositely directed major surfaces of said panels in contact to provide an interface therebetween;
(b) transmitting a laser beam of predetermined wavelength by a laser through said one panel to said interface;
(c) focusing said laser beam at a focal region on said interface;
(d) applying said laser beam to heat and melt a portion of said second panel at said interface;
(e) displacing said laser beam relative to said panels to melt a plurality of portions of said panels adjacent to said focal region to produce a corresponding plurality of melt zones formed at said interface, each of said melt zones consisting of a mixture of said portions of said panels; and
(f) cooling of said melt zone so that said panels become welded at said interface.

18. A method according to claim 17, wherein a pattern of said plurality of melt zones is selected from the group comprising spot, stitch, and continuous welds.

19. A method according to claim 17 further including the step of moderating an intensity of said laser beam so that heat damage to a visible surface of at least one of said panels is minimized.

20. A method according to claim 17, wherein said interface is a three dimensional surface and said laser is adjusted to maintain said focal region at said interface.

21. A method according to claim 17 further comprising the steps of incorporating additives to at least one of said panels for modifying transmission characteristics of said panel with respect to said predetermined wavelength of said laser beam.

22. A method according to claim 21 including the step of incorporating a pigment or dye in said second panel to enhance the absorption thereof at said predetermined wavelength.

23. A method according to claim 21 including the step of mixing primary colours for incorporation in said one panel to provide substantial absorption in the visible spectrum and transparency at said predetermined wavelength.

24. A method according to claim 22 wherein said one panel includes a plurality of fibres to form a carpet pile and a backing to secure said pile, said backing being transparent to said predetermined wavelength.

25. A method according to claim 24 wherein said fibres are absorptive to said predetermined wavelength and said method includes the step of separating said fibres to permit said beam to impinge upon said backing and be transmitted therethrough to said interface.

26. A method according to claim 24 wherein including the step of mixing primary colours and incorporating such mixture in said fibres to provide substantial absorption in said visible wavelength and transmission at said predetermined wavelength.

27. A method according to claim 26 including the step of a mixing said primary colours to be transmissive in the infrared range.

28. A panel for securing to a substrate to provide a finished component, said panel comprising a plurality of fibres to provide a carpet pile and a backing to secure said pile, said backing being transparent to a laser beam of a predetermined wavelength and said fibres having an additive to render them transparent to said predetermined wavelength and substantially absorptive of light in the visible spectrum, said backing being secured to said pile by the creation of a weld.

29. A panel according to claim 28 wherein said additive is provided by a mixture of dyes or pigments.

30. A panel according to claim 29 wherein said additive is a mixture of primary colours.

31. A panel according to claim 30 wherein said mixture is transmissive in the infrared spectrum.
